(19) United States
(12) Patent Application Publication
(10) Pub. No.: US 2017/0223419 A1
(43) Pub. Date: Aug. 3, 2017

(54) System and Method for Digital Content Aggregation, Curation, and Delivery

(71) Applicant: Jordan Nassie, Huntington Beach, CA (US)

(72) Inventor: Jordan Nassie, Huntington Beach, CA (US)

(21) Appl. No.: 15/156,218

(22) Filed: May 16, 2016

Related U.S. Application Data
(60) Provisional application No. 62/289,350, filed on Feb. 1, 2016.

(51) Int. Cl. H04N 21/472; H04N 21/231; H04N 21/61; H04N 21/414; H04N 21/482; H04N 21/81; H04L 29/08; H04N 21/232

(52) U.S. Cl. CPC H04N 21/47205; H04L 67/02; H04L 67/306; H04N 21/23109; H04N 21/232; H04N 21/41407; H04N 21/47202; H04N 21/4828; H04N 21/8173; H04N 21/6175

(57) ABSTRACT

System and method for digital content discovery, curation, and publishing of multiple channel content in a template-based digital content channel on a web page or site or through an application for mobile devices that can be reached from any Internet-accessible device, wherein the digital content on third party websites or servers is delivered through embedded players to provide seamless experience.

### INCORPORATION BY REFERENCE

This application claims the benefit of priority under 35 U.S.C. 119(e) to the filing date of U.S. provisional patent application No. 62/289,350 “System and Method for Digital Content Aggregation and Curation” which was filed on Feb. 1, 2016, and which is incorporated herein by reference in its entirety.

### FIELD OF INVENTION

The present invention relates generally to online digital content discovery, curation, and publishing, and more specifically to a system and method for compiling, curating, and displaying multiple channel content in a template-based content stream field for on-demand playback.

### BACKGROUND OF THE INVENTION

Currently, there are large collections of video dips available on web sites across the publicly-routed Internet. Users of Internet-accessible machines can navigate to such web sites and view those clips, using a web browser or browser plug-in. Also, Internet search engines provide end users with the capability of searching for video clips from these sites. It is also known in the prior art for web site hosting entities to provide tools and templates to facilitate the creation of web pages or sites, which pages or sites are then hosted by the entities for a recurring fee. These hosted sites also may include search capabilities.

Video curation is the process of sorting through the vast amounts of videos on the web and presenting it in a meaningful, coherent, and organized way around a specific theme. This can comprise, for example and not limitation, aggregating, qualifying, sifting, sorting, classifying, and arranging videos into the right play list, category, display time, upload time, file size, etc. This can also include arranging videos based on user preferences. Video curation can provide end-users with the best, most relevant video content for them. Video curation is generally done today either by professional curators, who continually watch videos and manually apply the above process, or by crowd sourcing where videos are rated by a large group of users.

Video curation is an important component for fixing gaps in third party content. Using curation with the existing crowd source or manual methods, however, can result in problems with scalability, accuracy, synchronization, and learning. Manually reviewing videos, for example, is difficult to scale, can be expensive, and generally can't be done continuously or in real time. The crowd source method, on the other hand, can have high failure rates and timeliness issues because crowd sourcing does not inherently accumulate knowledge. Also, using these techniques may not address all the issues mentioned above (e.g., disparate video web sources, quality, etc.).

Providing third party videos using new media is desirable for many video service providers, mobile operators' websites, and other front end service providers that want to present the up-to-date, popular, and relevant video content. You Tube, for example, provides a variety of web based videos including personal videos, advertisements, and professional movie trailers, among other things. Service providers, such as You Tube, face a number of challenges when using such content, however, including, but not limited to, finding relevant content, handling multiple media formats, and tagging and labeling issues. There are thousands of web sources for videos, for example, but the average person or content manager may only be familiar with a limited number of sources. As a result, relevant, valuable content may not be easily found and provided. In addition, digital video is presented in a number of different formats (e.g., .avi, .mpeg, .wmv), some of which require proprietary software to play.

This means there is no single standard for publishing videos on the internet. In addition, there is no single standard for monetizing videos among websites. You Tube, for example, provides compensation, in part, based on the number of “hits” a video receives (i.e., how many times it is watched). There is also no single standard for metadata structures. In other words, not all sites provide the duration, category, or other information for a video embedded in the video. In addition, monetizing third party content may result in a violation of its terms of use, or other legal issues.

There are also multiple streaming technologies (e.g., HTTP and RTMP) that may require multiple streaming platforms. Because there is little incentive to properly tag videos, and may, in some cases, be an incentive to mistag videos, there are many cases where users upload content and label it improperly. In other words, videos are tagged with irrelevant or misleading tags (e.g. uploading a violent video while tagging it as a cartoon). Presenting such videos on a commercial service can be quite harmful to the user and to the service provider as well.

There is also a problem with disparate video quality on the web. Since much of new media contains user generated content, semiprofessional content, professional content, and mixtures thereof, there is naturally a mix of video quality. The quality of a video provided at 480i compared to one provided at 1080p, for example, is significant. In addition, third party videos may not be available at all times due to temporal or geo based issues. If, for example, a video is located on a server that is down for maintenance, that video should preferably be marked as temporarily unavailable. Unavailability of content can be a major obstacle for a service provider trying to deliver high end service.

Much of the content available on the web can be illegal. User generated content web sites, for example, often contain content that was copied and published illegally (e.g., a popular TV series or movie that was recorded and uploaded to sharing web site), but was not discovered by the web sites filters. In addition, at present, there is no central video qualification relevancy authority. This means that videos may not be well sorted and classified (e.g., into categories of interest) or that the videos cannot be matched to a particular end-user's interests and preferences. Similarly, web videos usually have no connection between them, making watching each video a somewhat autonomous event. End users, on the other hand, may prefer to watch multiple videos on the same subject, for example.

What is needed, therefore, is a system that can locate and classify videos with a high degree of accuracy. The system should use information provided in a user's profile, updated periodically, to provide videos relevant to a user's current interests. The system should enable offensive, illegal, low-quality, or otherwise undesirable content to be removed either automatically or manually. It is to such a system that embodiments of the present invention are primarily directed.

Current video-sharing websites and applications, like YouTube and Vimeo, provide users with convenient venues through which to upload, store; and view video content. Though access to individual video segments is relatively straightforward, these services fail to provide convenient mechanisms by which distinct but related video segments may be presented to a user in a continuous video stream. To watch a concert, for example, users must typically choose multiple video segments of the concert. This is required because of the storage limits of video cameras and the upload limits of video-sharing websites. Thus, there is a need in the video stream field to create a new and useful system and method for compiling and playing a multi-channel video. This invention provides such a new and useful method.

### OBJECTIVE OF THE INVENTION

Accordingly, it is an object of this invention to provide a system and method for providing any Internet user with the ability to quickly set up and customize a digital content channel, as a web page or site or through an application for mobile devices that can be reached from any Internet-accessible device.

It is also an object of this invention to provide a system and method for managing online digital content that include digital content from multiple channels and content sources, including TV shows, movies, and Internet videos.

It is also an object of this invention to provide a system and method discovery of online digital content, in which users have access to hundreds of live television channels in one place, can search through the available digital content, and discover relevant content in which they may be interested.

It is also an object of this invention to provide a system and method for curating of online digital content, in which content curators hand-pick contents based on viewer preferences and tailored to viewer interests.

It is also an object of this invention to provide a system and method in which links to or embedded players for content is hosted on multiple third-party web sites, and web browsers or applications (“App” or “Apps”) such as from Google's Play Store, Amazon's App Store, or Apple's App Store, then display these independently-hosted videos in the context of the system's web pages.

It is also an object of this invention to provide a system and method in which the system does not copy, host, or serve those embedded videos, which typically are delivered by third parties under their own terms and licenses.

It is also an object of this invention to provide a system and method in which users can create their own profiles and follow their favorite television channels.

It is also an object of this invention to provide a system and method in which users can also browse channels and watch the television channels they like.

It is also an object of this invention to provide a system and method in which content curators can curate contents from over 100 channels of Internet video streaming including from YouTube as well as curate contents that content curators have uploaded.

It is also an object of this invention to provide a system and method in which content curators and partners can upload videos for by provides video links via a website.

It is also an object of this invention to provide a system and method for publishing or distribution of online digital content that can be streamed from a play list on websites and Apps.

It is also an object of this invention to provide a system and method publishing digital content for on-demand playback.

It is also an object of this invention to provide a system and method publishing digital content for delayed playback in which the digital content is downloaded and stored on the viewer's device for playback at a later time when the user may not have internet access to stream the digital content on-demand.

It is also an object of this invention to provide a system and method for publishing or distribution of online digital content on Apps and websites that are made available in multiple languages so that users can watch television channels in their own language.

It is also an object of this invention to provide a system and method that include tools for use by channel site creators to customize the look, feel, and page design.

It is also an object of this invention to provide a system and method in which all user information is stored on the Cloud and users following a channel can be accessed on any App.

These and other advantages and features of the present invention are described herein with specificity so as to make the present invention understandable to one of ordinary skill in the art.

### SUMMARY OF THE INVENTION

In one aspect of the invention, a digital content distribution system is disclosed comprising a content provider, an asset library wherein a plurality of digital content is deposited in the asset library by the content provider; one or more end-users and one or more end-user devices; a content curation module to present the digital content from the asset library to the end-user device; a content extraction platform comprising a second content curation module wherein the content extraction platform extracts the digital content from the asset library and the second content curation module to curate the digital content and to present the digital content to the end-user device. In one embodiment, the second content extraction platform is comprised of a spider module wherein the spider module extracts the digital content from the asset library. In one embodiment, the second content extraction platform wherein the spider module extracts the digital content from the asset library via the an API module of the asset library. In one embodiment, the second content curation module is comprised of a display module wherein the display module is a smartphone application. In one embodiment, the application is comprised of an user interface module wherein the user interface module manages a display interface of the application. In one embodiment, the interface module is comprised of a display modification module wherein the display modification module changes the display interface of the application. In one embodiment, the content extraction platform can provide one or more display interfaces of the application simultaneously. In one embodiment, one or more content extraction platform user can independently utilize the content extraction platform to provide different display interfaces of the smart phone application to the one or more end-user applications.

In another aspect of the invention; a method to distribute content is disclosed comprising a content provider, an asset library wherein a plurality of digital content is deposited in the asset library by the content provider; one or more end-users and one or more end-user devices; a content curation module to present the digital content from the asset library to the end-user device; a content extraction platform comprising a second content curation module wherein the content extraction platform extracts the digital content from the asset library and the second content curation module to curate the digital content and to present the digital content to the end-user device. In one embodiment of the method, the second content extraction platform is comprised of a spider module wherein the spider module extracts the digital content from the asset library.

In one embodiment of the method, the second content extraction platform wherein the spider module extracts the digital content from the asset library via the an API module of the asset library. In one embodiment of the method, the second content curation module is comprised of a display module wherein the display module is a smartphone application. In one embodiment of the method, the application is comprised of an user interface module wherein the user interface module manages a display interface of the application. In one embodiment of the method, the interface module is comprised of a display modification module wherein the display modification module changes the display interface of the application. In one embodiment of the method, the content extraction platform can provide one or more display interfaces of the application simultaneously. In one embodiment of the method, one or more content extraction platform user can independently utilize the content extraction platform to provide different display interfaces of the smart phone application to the one or more end-user applications.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is a high-level diagram illustrating an overview of a typical digital content aggregation, curation, and distribution system and method.

FIG. 2 is a high-level diagram illustrating an overview of the digital content aggregation, curation, and distribution system and method in accordance with one embodiment of the present invention disclosed herein.

FIG. 3 is another high-level diagram illustrating an overview of the front-end and back-end interface of the digital content aggregation, curation, and distribution system and method in accordance with one embodiment of the present invention disclosed herein.

FIG. 4 is a simulated screen shot illustrating a website interface of the digital content aggregation, curation, and distribution system and method in accordance with one embodiment of the present invention.

FIG. 5 is a simulated screen shot of a website providing links for downloading the associated application on Google's Google Play store and on Apple's App Store for installation on respective mobile devices.

FIG. 6 is a simulated screen shot of the Apple's App Store page describing the iOS application for installation on mobile device as the front-end interface of the digital content aggregation, curation, and distribution system and method in accordance with one embodiment of the present invention.

FIG. 7 is a simulated screen shot illustrating a mobile device application interface of a digital content aggregation, curation, and distribution system and method in accordance with one embodiment of the present invention.

FIG. 8 is another simulated screen shot illustrating a mobile device application interface of a digital content aggregation, curation, and distribution system and method in accordance with one embodiment of the present invention.

FIG. 9 is another simulated screen shot illustrating a mobile device application interface of a digital content aggregation, curation, and distribution system and method in accordance with one embodiment of the present invention.

FIG. 10 is a simulated screen shot of the Google's Play Store page describing the Android application for installation on mobile device as the front-end interface of the digital content aggregation, curation, and distribution system and method in accordance with one embodiment of the present invention.

FIG. 11 is a high-level diagram illustrating of an overview of the digital content aggregation, curation, and distribution system and method in accordance with another embodiment of the present invention disclosed herein.

### DETAILED DESCRIPTION OF THE INVENTION

The following outlines some of the more pertinent features of the invention. These features should be construed to be merely illustrative. Many other beneficial results can be attained by applying the disclosed invention in a different manner or by modifying the invention as will be described.

Generally, the system and method of the present invention provide any Internet user with the ability to quickly set up and customize a digital content channel, as a web page or site or through an application for mobile devices that can be reached from any Internet-accessible device. Specifically, the system and method of the current invention provides for content curators to curate digital content easily and efficiently according to the preferences and interests of the viewers.

In one embodiment, the system and method provides for a free online television service broadcasting live channels full of TV shows, movies, and Internet videos hand-picked by content curators. Content curators can curate their own contents that plays out on websites and applications (“App” or “Apps”) such as from Google's Play Store, Amazon's App Store, or Apple's App Store. Content curators can curate contents from over 100 channels of Internet video streaming including from YouTube. Content curators can curate contents they have uploaded and the videos can be played live from a play list on the App or on a partner website. The App and websites are made available in multiple languages so that users can watch television channels in their own language.

In particular, users can watch curated television with content tailor to their interest. The content can be played on many websites and Apps. This allows users to have access to hundreds of live television channels in one place. Users can create their own profiles and follow their favorite television channels. Users can also browse channels and watch the television channels they like.

Content curators and partners can upload videos for by provides video links via a website. For example, curators can provide a YouTube video link through a website for uploading. Curators can then curate their own content that plays on the system. When users follow a partner television channel, partners can send users information notifications about the content that is playing on their channel daily.

In another aspect of the invention, the system and method of the present invention provide links to or embedded players for content that is hosted on multiple third-party web sites. Web browsers then display these independently-hosted videos in the context of the system's web pages. It is not required that the system copy, host, or serve those embedded videos, which typically are delivered by third parties under their own terms and licenses.

In another aspect of the invention, the system and method of the present invention include tools for use by channel site creators to customize the look, feel, and page design. In one embodiment, a particular web page or site may be associated with a given subject. As used herein, a page or site that has such an association is sometimes referred to as “subject-specific.” Although not meant to be limiting, once a subject-specific channel is created, the content curator can search across the web and choose to bring those search results into the channel architecture. The system also enables a multi-platform search as an integrated part of a library build. Furthermore, if desired, search results can be populated into the channel content.

The system also enables the characterization of the material returned, preferably according to a user-generated taxonomy. In one embodiment, the taxonomy may be developed from a collaborative filtering review that extends beyond the search characteristics. The system thus facilitate the process of discovery and organization within a vertical channel of online video content, drawing in videos from all over the Internet, and collecting them in new topical contexts, where they can be annotated by members of a social network, online community, or other group with a shared interest.

All user information is stored on the Cloud and users following a channel can be accessed on any App.

### DETAILED DESCRIPTION OF THE DRAWINGS

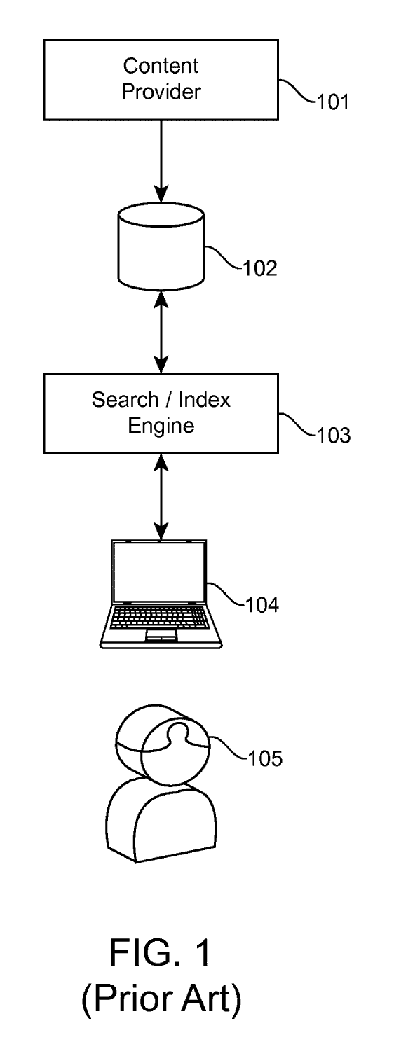

Referring to FIG. 1, this is a high-level diagram illustrating a typical digital content distribution system 100. In practice, a content provider 101 stores a plurality of digital content assets in an asset library 102. As used herein, the term “asset” broadly includes any machine-readable and/or machine-storable files containing digital content, or a pointer, placeholder, unique reference locator (URL), or equivalent means for redirecting an end-user 105 to the digital content. Digital content may include any digital video, music, pictures, or equivalents thereof. The end-user 105 employs an end-user device 104 to access the assets via a distribution platform; such as a website, mobile application, TV widget, or equivalents thereof. The end-user 105 may use a search/index engine 103 to query the asset library 102 for an asset of interest. Search queries are typically conducted based on tags, keywords, and/or associated metadata linked to individual assets. Recommendation engines are also known, which may recommend assets to the end-user 105, based on the tags, keywords, and/or associated metadata.

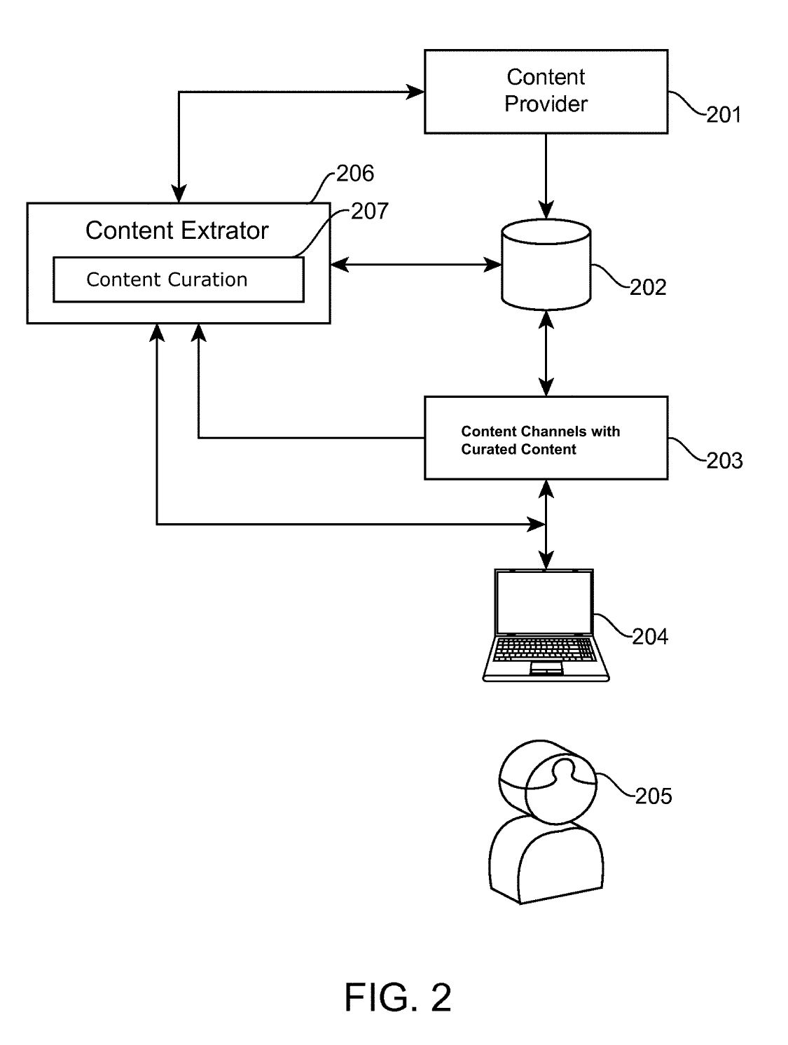

Referring to FIG. 2, this is a high-level diagram illustrating a digital content distribution system 200, in accordance with one embodiment of the present invention. Similar to the system 100 described above with respect to FIG. 1, this system 200 includes a content provider 201, whom stores a plurality of digital content assets in an asset library 202. An end-user 205 employs an end-user device 204 to access the assets via a distribution platform; such as a website, mobile application, TV widget, or equivalents thereof. The end-user 205 is provided with curated content from selected channels 203 that query the asset library 202 for an asset of interest.

System 200 of FIG. 2, however, differs from system 100 of FIG. 1 in that a content extractor 206 performs the function of curating and organizing assets within asset library 202. The content extractor 206 ultimately provides to the distribution platform on the end-user device 204. More specifically, in one embodiment, the content extractor 206 hand-picks or curates 207 the contents and organizes, scores, ranks, orders, and/or re-orders assets into an asset play list based on similarity metrics between assets and/or end-user behavior.

The content extractor 206 may also have a direct (or indirect) link to the end-user 205, in order to obtain and/or analyze the end-user's behavioral information and/or profile. For example, the content extractor 206 may obtain end-user behavior or intent information in the form of: system data, link access data, share data, search query, end-user ratings of one or more assets, viewing history, end-user interaction with an initially-viewed asset, end-user interaction (e.g., likes/dislikes, saves, volume played, adding to playlist, percentage of video watched, sharing with friends, additional requests for similar content, etc.) with one or more assets in the content graph, and any combination or equivalents thereof.

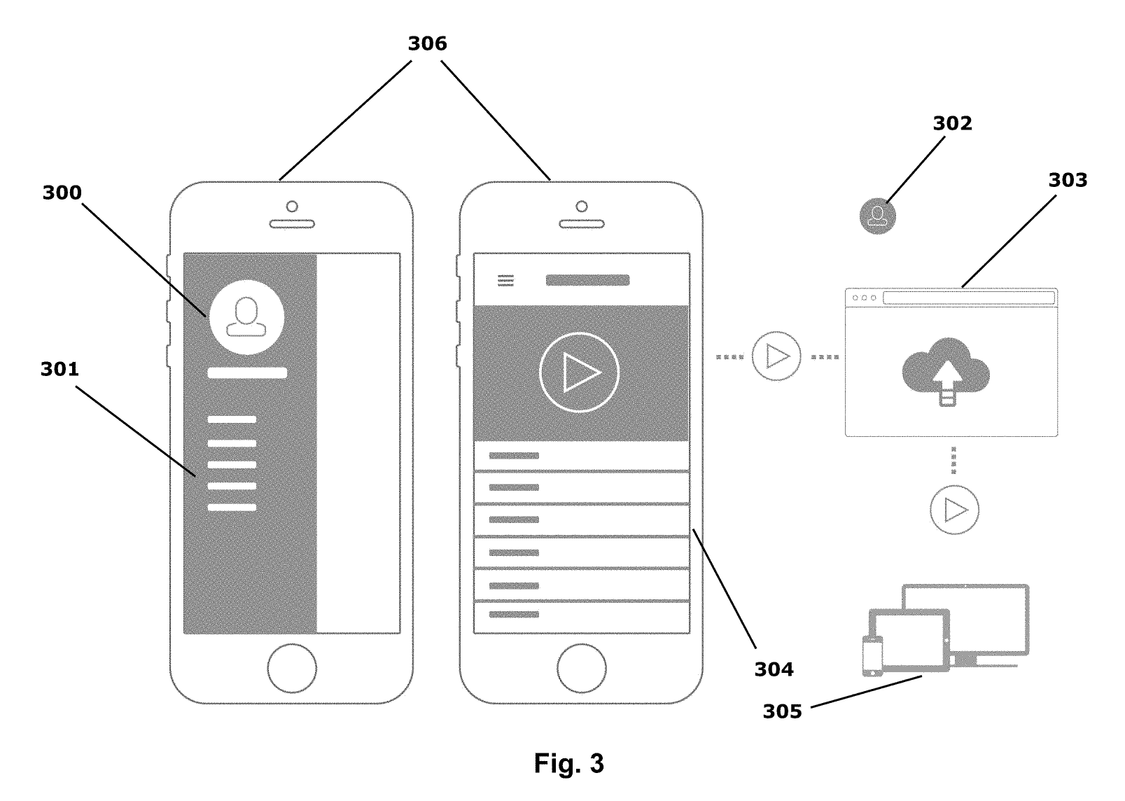

Referring to FIG. 3, this is another high-level diagram illustrating an overview of the front-end and back-end interface of the digital content aggregation, curation, and distribution system and method in accordance with one embodiment of the present invention disclosed herein. In particular, a user 300 can subscribe to one or more content curators and have a following 301. The content provider 302 can upload content through the channel upload site 303, and a content curator who can also be the content provider 302 can organize the content that are uploaded into the channel upload site 303 into different channels 304 that can be played through a web browser or through an App on all devices 305, including mobile devices 306. Mobile devices 306 can link 307 to contents that were uploaded through the channel upload site 303 via mobile Apps. Other devices 305 can also link 308 to contents that were uploaded through the channel upload site 303 via web browsers.

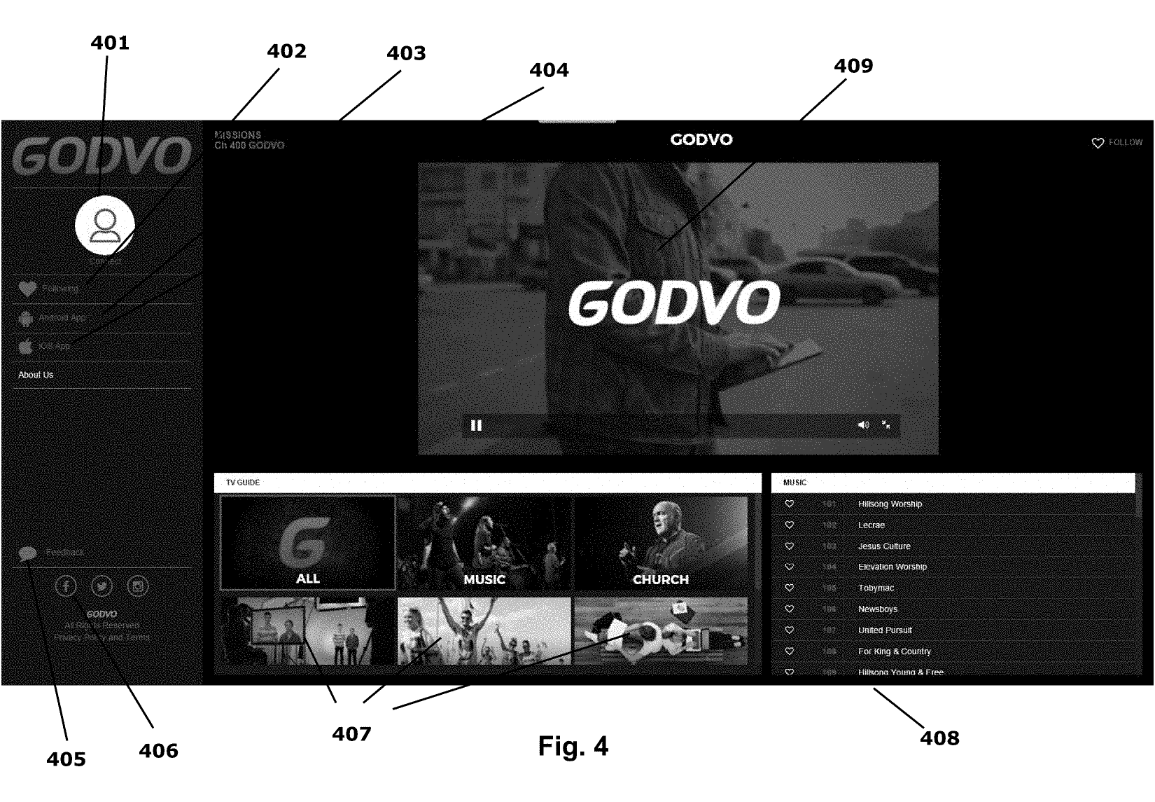

FIG. 4 is a screen shot illustrating a website interface of the digital content aggregation, curation, and distribution system and method in accordance with one embodiment of the present invention. In particular, a user 401 can subscribe to one or more content curator and follow the content hand-picked by the curator. The “Following” section 402 lists the curators or channels that the user 401 is following. Generally, when the user 401 finds that content from a particular curator or channel is preferred, the user 401 can add that curator or channel to his or her list of curators of channels to follow. The user 401 can access the content through web browser, through Google's Android App 403, and through Apple's iOS App 404. The user 401 also provide feedback 405 or share with other friends and family through various social networks 406 such as Facebook, Twitter and Instagram.

Specifically, the contents are separated into different categories 407 for easy access. For example, categories 407 can include “music,” “church,” “education,” “kids,” etc. Upon selection of a category 407, the user will be provided with a list of channels 408 under that category 407. For example, upon selecting the “music” category, the user is provided with a list of channels 408 that provides contents relating to music. Each channel is curated by a content curator who hand-picks the content on that particular channel. The content 409 can be played on-demand on the website or through various Apps. The user 401 can play, pause, continue, and replay or terminate the content 409 as desired. If the user 401 likes the contents curated by a particular channel's curator, the user 401 can subscribe to that channel, and the channel will be listed for easy access by the user 401 every time the user 401 is logged into his or her account. This will allow the user 401 to quickly access his or her preferred channels without having to search and find the channel every time. The user 401 can store multiple preferred channels in his or her account.

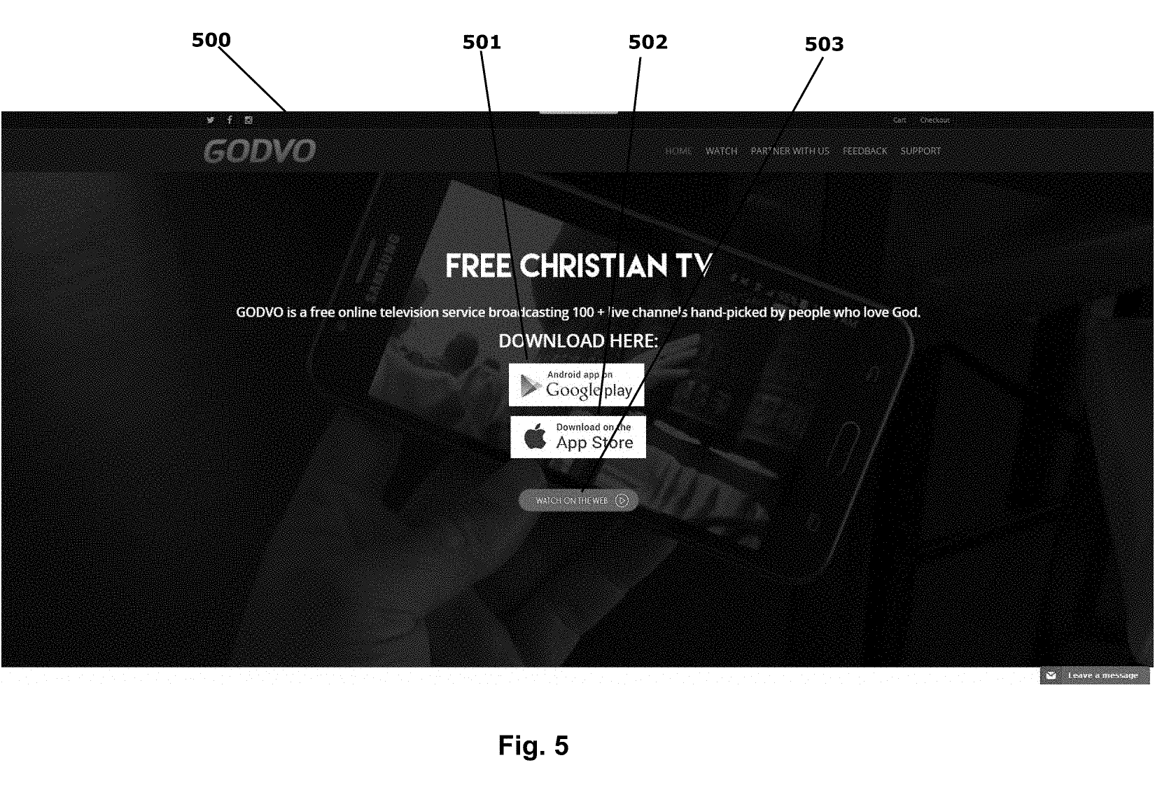

FIG. 5 is a screen shot of a website providing links for downloading the associated application on Google's Google Play store and on Apple's App Store for installation on respective mobile devices. In one embodiment of the present invention disclosed herein, a user is able to access the system and services through Google's Android App by downloading and installing the App on the Google Play store 500. Alternatively, the user is also able to access the system and services through downloading and installing the App on Apple's App Store 501. If the user is not using an Android or iOS device, the user can also access the system and services on the Internet 503. The user can sign up for an account in which the user's data including subscribed channels and viewing history will be synchronized. Therefore, if the user switches from using the system and services on a desktop through a web browser and switches to an Android device, the user will be able to smoothly transition from the desktop to a mobile phone without interruption.

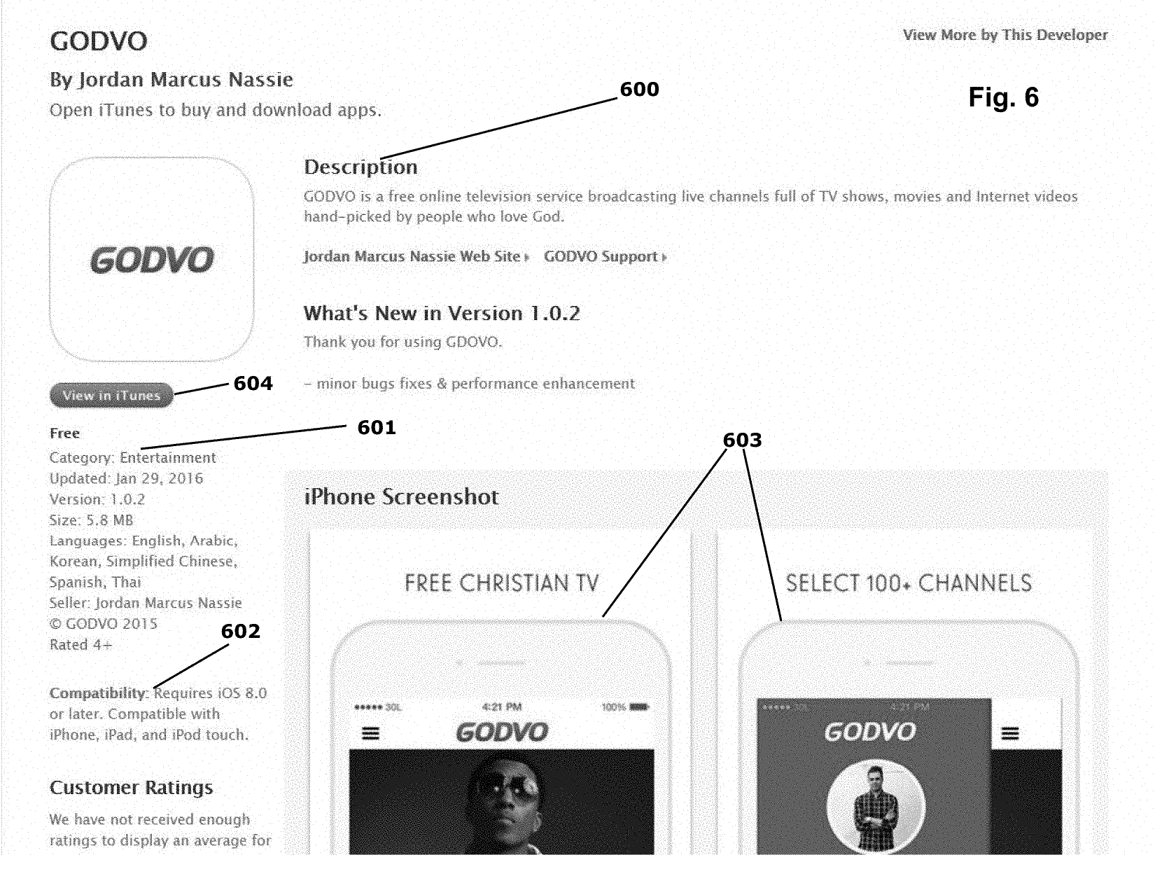

Referring to FIG. 6, this is a screen shot of the Apple's App Store page describing the iOS application for installation on mobile device as the front-end interface of the digital content aggregation, curation, and distribution system and method in accordance with one embodiment of the present invention. The App Store page for the App includes a description 600 of the App, details 601 of the App, compatibility 602 of the App, several screen shots 603 of the App on iOS devices, and a link 604 to view the App on iTunes.

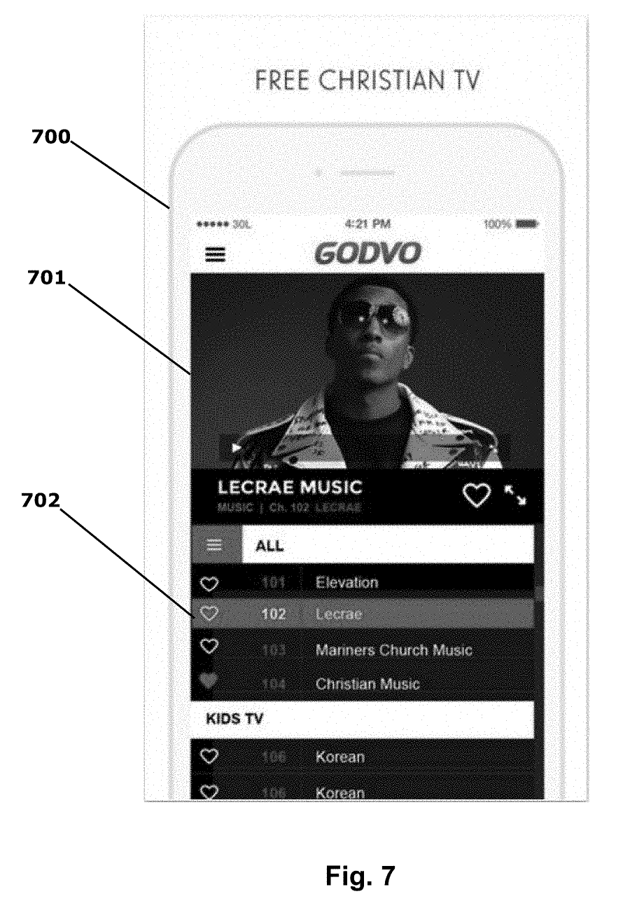

Referring to FIG. 7, this is a simulated screen shot illustrating a mobile device application interface of a digital content aggregation, curation, and distribution system and method in accordance with one embodiment of the present invention. In particular, the simulated screen shot illustrates a mobile device 700 with the App playing a video content 701 from one of the channels 702. Specifically, the App is shown playing a video from the “Music” category playing the “Lecrae” channel. The user is able to select other channels 702 which will display corresponding curated content from each channel.

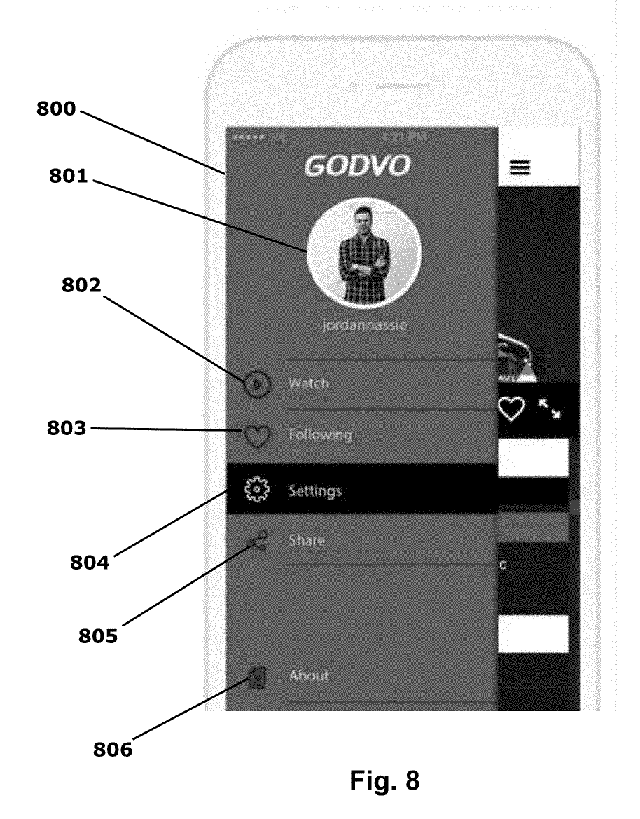

Referring to FIG. 8, this is another simulated screen shot illustrating a mobile device application interface of a digital content aggregation, curation, and distribution system and method in accordance with one embodiment of the present invention. In particular, the simulated screen shot illustrates the menu 800 of the App on a mobile device. The menu 800 includes the user and profile 801 option to continue watching content 802, a list of channels the user is following 803, settings 804 for the user's account, option to share 805 the content, and an “about” section 806 provide more detail.

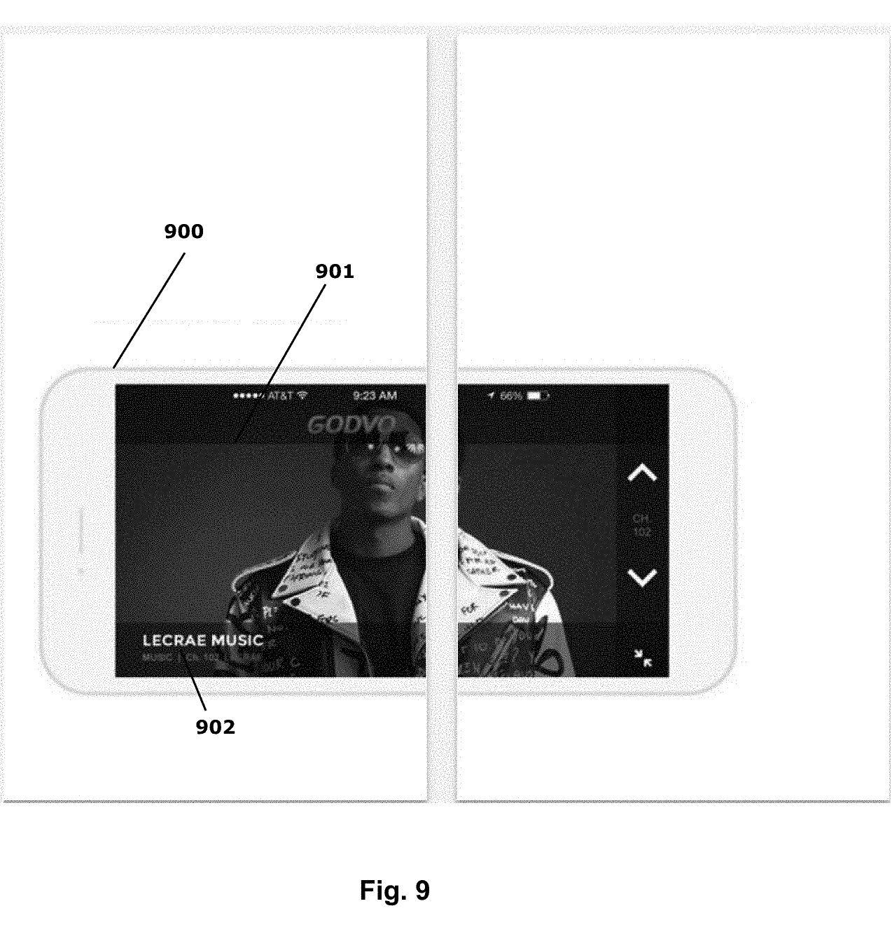

Referring to FIG. 9, this is another screen shot illustrating a mobile device application interface of a digital content aggregation, curation, and distribution system and method in accordance with one embodiment of the present invention. In particular, the simulated screen shot is of a mobile device 900 displaying the content 901 from the channel “Lecrae” 902. The content 901 is set to displaying full screen on the mobile device 900 so the user can take full advantage of the mobile screen to enjoy a better viewing experience.

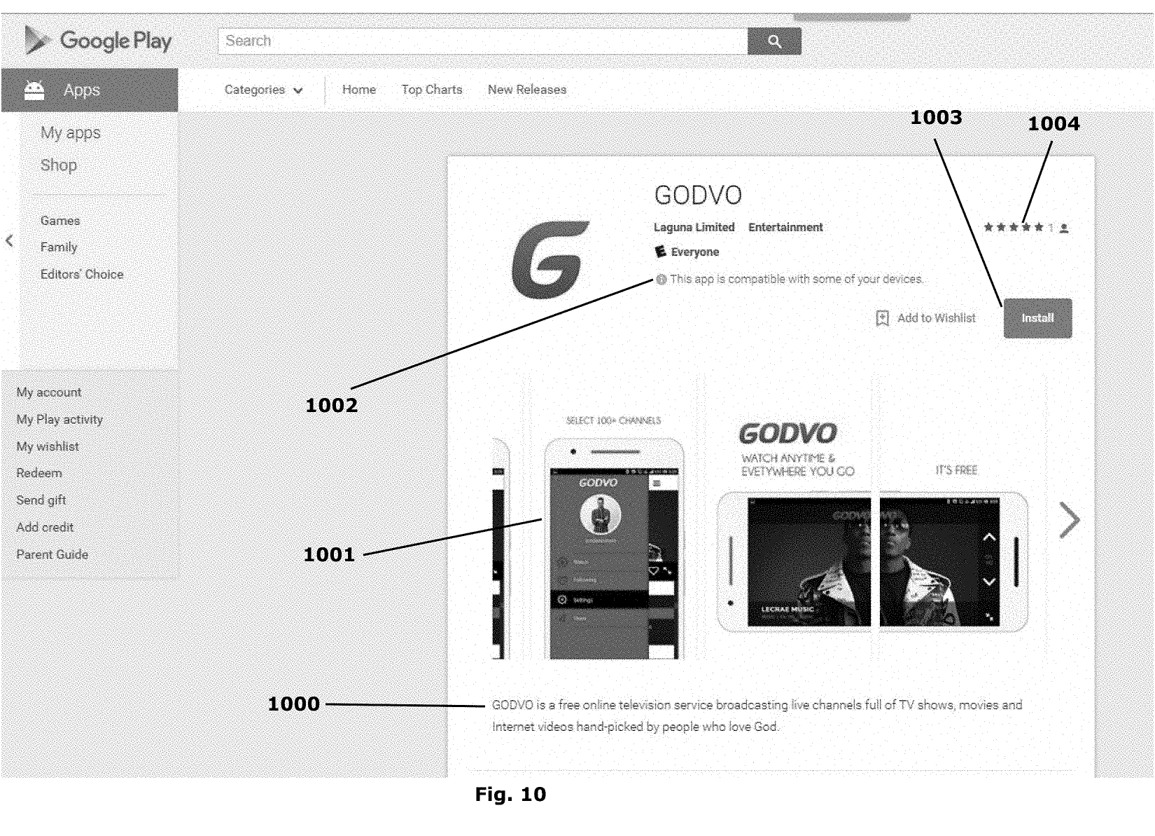

Referring to FIG. 10, this is a simulated screen shot of the Google's Play Store page describing the Android application for installation on mobile device as the front-end interface of the digital content aggregation, curation, and distribution system and method in accordance with one embodiment of the present invention. The Play store page for the App includes a description 1000 of the App, several screen shots 1001 of the App, details 1002 of the App, a link 1003 to install the App on the user's Android devices, and reviews 1004 of the App.

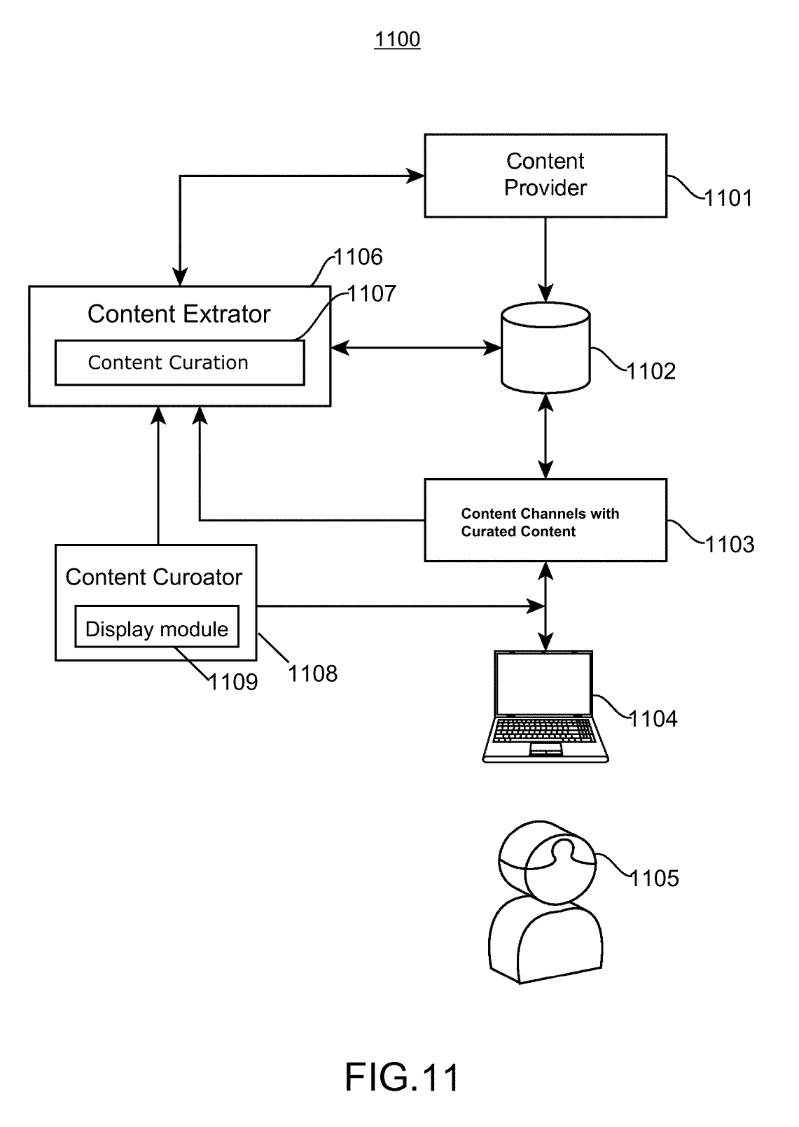

Referring to FIG. 11, this is a high-level diagram illustrating a digital content distribution system 1100, in accordance with one embodiment of the present invention. This system 1100 includes a content provider 1101, whom stores a plurality of digital content assets in an asset library 1102. A content extractor 1106 performs the function of curating and organizing assets within asset library 1102. The content extractor 1106 ultimately provides to the distribution platform on the end-user device 1104.

More specifically, in one embodiment, the content extractor 1106 hand-picks or curates 1107 the contents and organizes, scores, ranks, orders, and/or re-orders assets into an asset play list based on similarity metrics between assets and/or end-user behavior. An end-user 1105 employs an end-user device 1104 to access the assets via a distribution platform; such as a website, mobile application, TV widget, or equivalents thereof. The end-user 1105 is provided with curated content from selected channels 1103 that query the asset library 1102 for an asset of interest.

The content extractor 1106 is further linked to another content curator 1106 which includes a display module 1107 wherein the display module 1107 can manage the display interface of the end-user's display, or to provide a “skin” for the display interface. More specifically, the system is able to provide curated content along with a desired display or “skin” to the end-user 1105 viewing the content to deliver a smooth viewing experience. Therefore, the delivery method and system, including the content and the display, are well-integrated and will provide a seamless experience.

1. A digital content distribution system comprising a content provider, an asset library wherein a plurality of digital content is deposited in said asset library by said content provider; one or more end-users and one or more end-user devices; a content curation module to present said digital content from said asset library to said end-user device; a content extraction platform comprising a second content curation module wherein said content extraction platform extracts said digital content from said asset library and said second content curation module to curate said digital content and to present said digital content to said end-user device.

2. The system of claim 1 wherein said content extraction platform
is comprised of a spider module wherein said spider module extracts said digital content from said asset library.

3. The system of claim 1 wherein said content extraction platform
wherein said spider module extracts said digital content from said asset library via said an API module of said asset library.

4. The system of claim 1 wherein said second content curation module is comprised of a display module wherein said display module is a smart phone application.

5. The system of claim 4 wherein said application is comprised of an user interface module wherein said user interface module manages a display interface of said application.

6. The system of claim 5 wherein said interface module is comprised of a display modification module wherein said display modification module changes said display interface of said application.

7. The system of claim 6 wherein said content extraction platform can provide one or more display interfaces of said application simultaneously.

8. The system of claim 7 wherein one or more content extraction platform user can independently utilize said content extraction platform to provide different display interfaces of said smart phone application to said one or more end-user applications.

9. A method to distribute content comprising a content provider, an asset library wherein a plurality of digital content is deposited in said asset library by said content provider; one or more end-users and one or more end-user devices; a content curation module to present said digital content from said asset library to said end-user device; a content extraction platform comprising a second content curation module wherein said content extraction platform extracts said digital content from said asset library and said second content curation module to curate said digital content and to present said digital content to said end-user device.

10. The method of claim 9 wherein said second content extraction platform is comprised of a spider module wherein said spider module extracts said digital content from said asset library.

11. The method of claim 9 wherein said second content extraction platform wherein said spider module extracts said digital content from said asset library via said an API module of said asset library.

12. The method of claim 9 wherein said second content curation module is comprised of a display module wherein said display module is a smartphone application.

13. The method of claim 12 wherein said application is comprised of an user interface module wherein said user interface module manages a display interface of said application.

14. The method of claim 13 wherein said interface module is comprised of a display modification module wherein said display modification module changes said display interface of said application.

15. The method of claim 14 wherein said content extraction platform can provide one or more display interfaces of said application simultaneously.

16. The method of claim 15 wherein one or more content extraction platform user can independently utilize said content extraction platform to provide different display interfaces of said smart phone application to said one or more end-user applications.
